(19) United States
(12) Patent Application Publication
(10) Pub. No.: US 2024/0182023 A1
(43) Pub. Date: Jun. 6, 2024

(54) COLLISION AVOIDANCE SUPPORT DEVICE AND METHOD

(71) Applicant: TOYOTA JIDOSHA KABUSHIKI KAISHA, Toyota-shi (JP)

(72) Inventors: Yutaro TOMOTSUNE, Susono-shi (JP); Takashi Hasegawa, Susono-shi (JP)

(73) Assignee: TOYOTA JIDOSHA KABUSHIKI KAISHA, Toyota-shi (JP)

(21) Appl. No.: 18/527,868

(22) Filed: Dec. 4, 2023

(30) Foreign Application Priority Data
Dec. 6, 2022 (JP) 2022-195020

(51) Int. Cl. B60W 30/09; B60W 10/18; B60W 30/095; B60W 30/18; B60W 40/06

(52) U.S. Cl. CPC B60W 30/09; B60W 10/18; B60W 30/0956; B60W 30/18159; B60W 40/06; B60W 2552/05

(57) ABSTRACT

A collision avoidance support device configured to determine whether or not automatic braking for decelerating an own vehicle should be executed based on a predetermined determination condition in a situation where it is determined that there is a possibility of a collision between another vehicle traveling on a road intersecting an own vehicle road and the own vehicle, to decelerate the own vehicle by the automatic braking when it is determined that the automatic braking should be executed, and further to, when it is determined that the own vehicle road is a non-priority road, make it easier to be determined that the automatic braking should be executed by relaxing the predetermined determination condition as compared to when it is determined that the own vehicle road is not a non-priority road.

### CROSS-REFERENCE TO RELATED APPLICATION

This application claims priority to Japanese Patent Application No. JP2022-195020 filed on Dec. 6, 2022, the content of which is hereby incorporated by reference in its entirety into this application.

### BACKGROUND

### 1. Technical Field

The present disclosure relates to a collision avoidance support device, a collision avoidance support method, and a non-transitory computer-readable storage medium storing a program for executing a collision avoidance support control.

### 2. Description of the Related Art

As one of collision avoidance support devices, there is known a collision avoidance support device by automatic braking for avoiding an encountered collision at an intersection or the like. This type of collision avoidance support device is configured to decelerate and stop an own vehicle by automatic braking when it is determined that another vehicle traveling toward a road on which the own vehicle travels (referred to as “own vehicle road”) on a road (referred to as “other vehicle road”) intersecting the own vehicle road and the own vehicle may collide with each other and the automatic braking is necessary.

In a situation where there is a risk of an encountered collision, if the other vehicle is shortly stopped by braking and the own vehicle is also stopped by automatic braking, the encountered collision can be prevented, but in particular, if the own vehicle road is a priority road, the own vehicle is uselessly stopped.

In order to cope with this problem, Japanese Patent Application Laid-open No. 2021-187207 describes a collision avoidance support device that is configured not to permit automatic braking of an own vehicle before a time point when the other vehicle is no longer able to avoid a collision by braking, and to permit the automatic braking of the own vehicle at a time point when the other vehicle is no longer able to avoid the collision by braking.

In the conventional collision avoidance support device such as the collision avoidance support device described in the above-mentioned Laid-open publication, the own vehicle is not permitted to be automatically braked until a time point where the other vehicle cannot avoid a collision by braking. Therefore, since the automatic braking of the own vehicle is delayed, in particular, when the own vehicle road is a non-priority road, the prevention of the encountered collision cannot help be delayed.

### SUMMARY

The present disclosure provides a collision avoidance support device, a collision avoidance support method, and a non-transitory computer-readable storage medium storing a program for executing a collision avoidance support control, which are improved so as not to delay automatic braking of an own vehicle while preventing the own vehicle from being uselessly stopped in a situation where there is a risk of an encountered collision.

According to the present disclosure, there is provided a collision avoidance support device comprising: a surrounding information acquisition device that acquires surrounding information around an own vehicle; and an electronic control unit configured to determine whether or not automatic braking for decelerating the own vehicle should be executed based on a predetermined determination condition in a situation where it is determined that there is a possibility of a collision between another vehicle traveling on a road intersecting an own vehicle road and the own vehicle based on the information acquired by the surrounding information acquisition device, and to decelerate the own vehicle by the automatic braking when it is determined that the automatic braking should be executed.

The electronic control unit is configured to, when it is determined that the own vehicle road is a non-priority road based on the information acquired by the surrounding information acquisition device, make it easier to be determined that the automatic braking should be executed by relaxing the predetermined determination condition as compared to when it is determined that the own vehicle road is not a non-priority road.

Further, according to the present disclosure, there is provided a collision avoidance support method comprising a step of determining whether or not there is a possibility that another vehicle traveling on a road intersecting an own vehicle road toward the own vehicle road may collide with an own vehicle based on surrounding information around the own vehicle acquired by a surrounding information acquisition device, a step of determining whether or not automatic braking for decelerating the own vehicle should be executed based on a predetermined determination condition, and a step of decelerating the own vehicle by the automatic braking when it is determined that the automatic braking should be executed.

The collision avoidance support method further comprises a step of determining whether or not the own vehicle road is a non-priority road based on the information acquired by the surrounding information acquisition device, and a step of, when it is determined that the own vehicle road is a non-priority road, making it easier to be determined that the automatic braking should be executed by relaxing the predetermined determination condition as compared to when it is determined that the own vehicle road is not a non-priority road.

Further, according to the present disclosure, a non-transitory computer-readable storage medium storing a program for executing collision avoidance support control is provided. The program causes an electronic control unit mounted on an own vehicle to execute a step of determining whether or not there is a possibility that another vehicle traveling on a road intersecting an own vehicle road toward the own vehicle road may collide with the own vehicle based on surrounding information around the own vehicle acquired by a surrounding information acquisition device, a step of determining whether or not automatic braking for decelerating the own vehicle should be executed based on a predetermined determination condition, and a step of decelerating the own vehicle by the automatic braking when it is determined that the automatic braking should be executed.

The program further comprises a step of determining whether or not the own vehicle road is a non-priority road based on the information acquired by the surrounding information acquisition device, and a step of, when it is determined that the own vehicle road is a non-priority road, making it easier to be determined that the automatic braking should be executed by relaxing the predetermined determination condition as compared to when it is determined that the own vehicle road is not a non-priority road.

According to the collision avoidance support device, the collision avoidance support method, and the collision avoidance support program described above, when it is determined that the own vehicle road is a non-priority road, it is made easier to determine that the automatic braking should be executed by relaxing the predetermined determination condition as compared to where it is determined that the own vehicle road is not a non-priority road.

Therefore, when it is determined that the own vehicle road is a non-priority road, the automatic braking is executed earlier than when it is determined that the own vehicle road is not a non-priority road. Therefore, it is possible to prevent the automatic braking of the own vehicle from being delayed in a situation where there is a risk of an encountered collision, and to prevent the encountered collision.

When it is determined that the own vehicle road is not a non-priority road, the predetermined determination condition is not relaxed, so that it is possible to prevent the own vehicle from being stopped unnecessarily due to the automatic braking being executed at an early stage.

In another aspect of the present disclosure, the determining as to whether or not the automatic braking should be executed includes determining whether or not an estimated collision mode is included in a preset collision mode range, and the electronic control unit is configured to relax the predetermined determination condition by expanding the preset collision mode range when it is determined that the own vehicle road is a non-priority road as compared to when it is determined that the own vehicle road is not a non-priority road.

According to the above aspect, when it is determined that the own vehicle road is a non-priority road, the predetermined determination condition is relaxed by expanding the preset collision mode range as compared to when it is determined that the own vehicle road is not a non-priority road. Therefore, when it is determined that the own vehicle road is the non-priority road, it is made easier to determine that the estimated collision mode is included in the preset collision mode range than when it is determined that the own vehicle road is not a non-priority road. Therefore, it can be made easier to determine that the automatic braking should be executed.

Further, in another aspect of the present disclosure, the determining as to whether or not the automatic braking should be executed includes a permission determination as to whether or not the automatic braking is permitted to be executed, and the electronic control unit is configured to relax a predetermined determination condition by changing a reference value of the determination as to whether or not the automatic braking is permitted so that the permission determination is performed earlier when it is determined that the own vehicle road is a non-priority road as compared to when it is determined that the own vehicle road is not a non-priority road.

According to the above aspect, when it is determined that the own vehicle road is a non-priority road, the predetermined determination condition is relaxed by changing the reference value of the determination as to whether or not the automatic braking is permitted so that the permission determination of the automatic braking is performed earlier than when it is determined that the own vehicle road is not a non-priority road. Therefore, when it is determined that the own vehicle road is a non-priority road, the permission determination of the automatic braking is performed earlier than when it is determined that the own vehicle road is not a non-priority road, so that the automatic braking can be started early.

It is to be noted that in the present application, a road on which the own vehicle travels is referred to as an “own vehicle road”, and a road on which another vehicle that may collide with the own vehicle travels is referred to as an “other vehicle road”.

Other objects, other features and attendant advantages of the present disclosure will be readily understood from the description of an embodiment of the present disclosure described with reference to the following drawings.

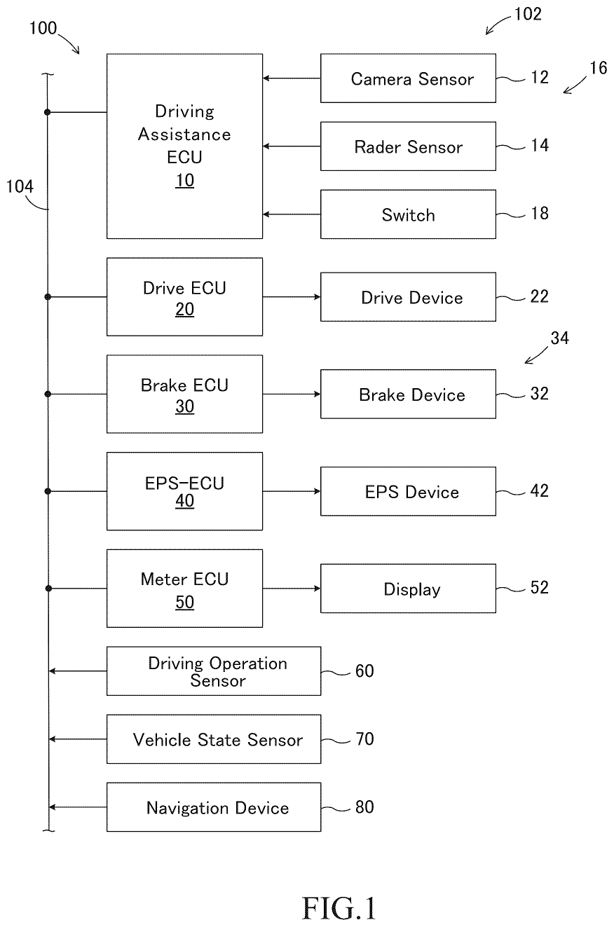

FIG. 1 is a schematic configuration diagram showing a collision avoidance support device according to the embodiment.

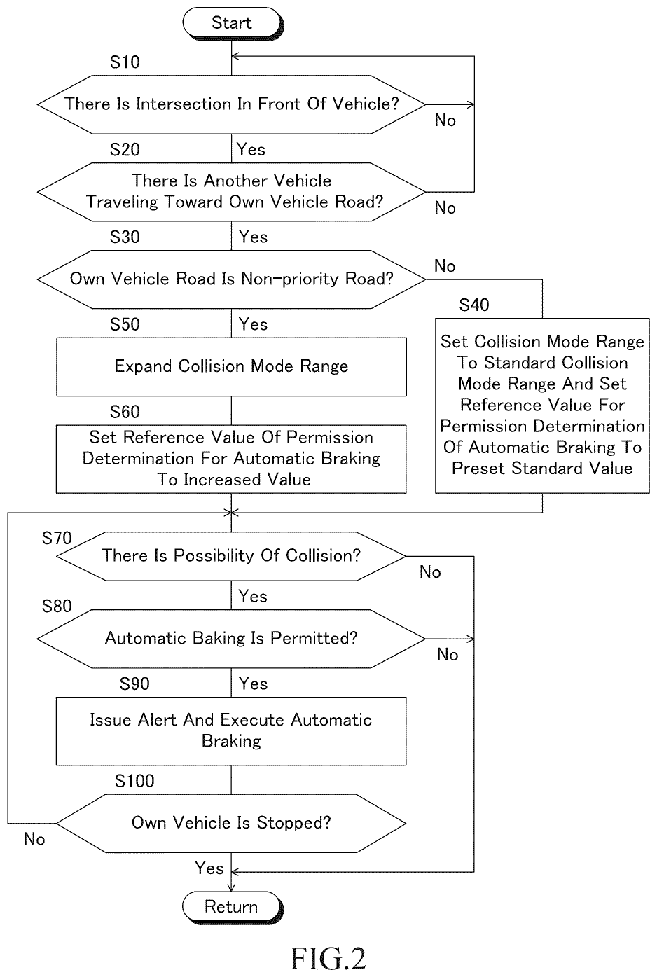

FIG. 2 is a flowchart showing a collision avoidance support control routine in the embodiment.

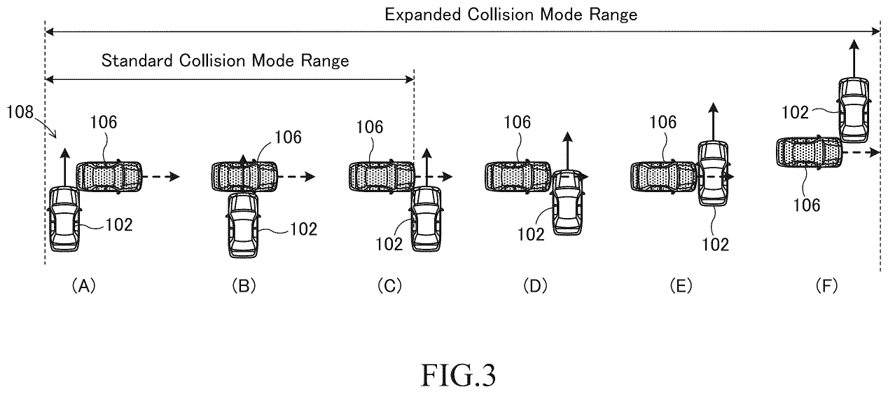

FIG. 3 is a diagram showing modes of an encountered collision at an intersection.

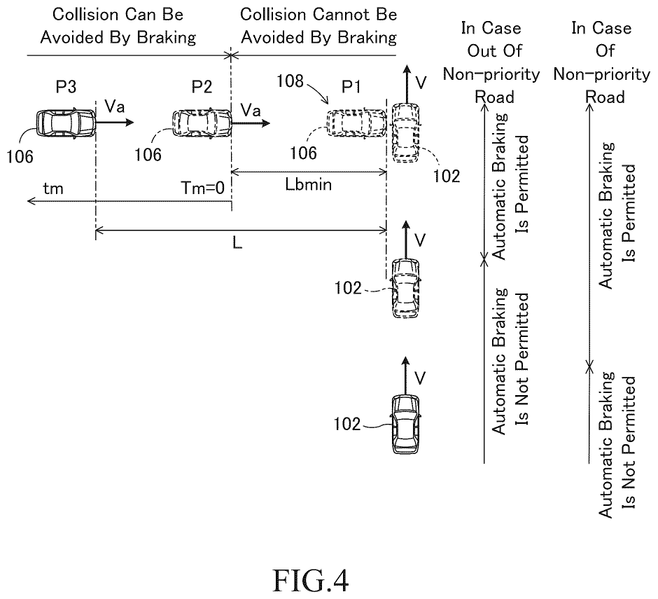

FIG. 4 is a diagram for explaining a timing of permission of automatic braking of an own vehicle.

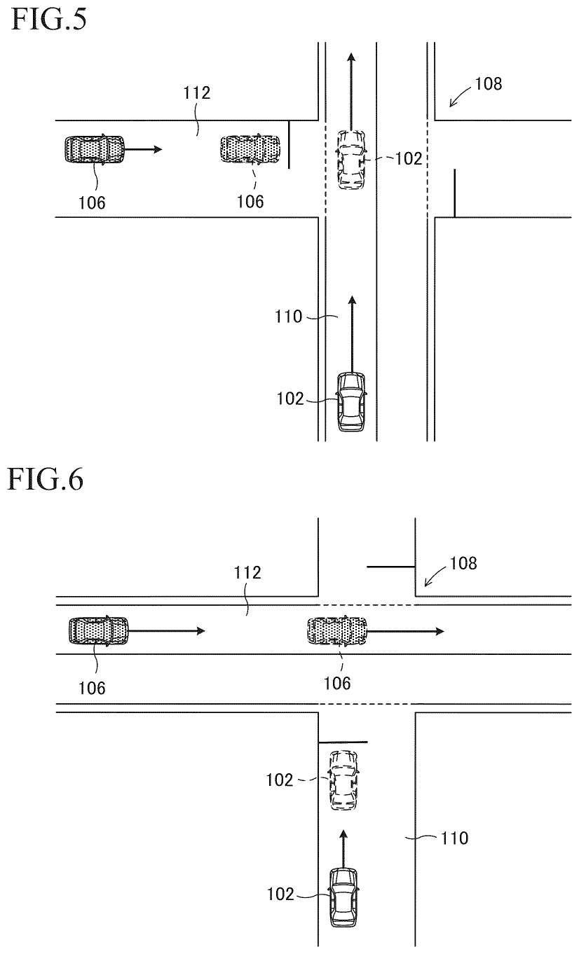

FIG. 5 is a diagram showing a case where it is not determined that an own vehicle road is a non-priority road.

FIG. 6 is a diagram showing a case where it is determined that an own vehicle road is a non-priority road.

A collision avoidance support device, a collision avoidance support method and, and a non-transitory computer-readable storage medium storing a program for executing collision avoidance support control according to the embodiment of the present disclosure will be described in detail below with reference to the accompanying drawings.

As shown in FIG. 1, a collision avoidance support device 100 according to an embodiment of the present disclosure is applied to a vehicle 102 and includes a driving assistance ECU 10. The vehicle 102 may be a vehicle capable of autonomous driving. As shown in FIG. 1, the vehicle 102 includes a drive ECU 20, a brake ECU 30, an electric power steering ECU 40, and a meter ECU 50. ECU means an electronic control unit having a microcomputer as its main part. In the following description, the electric power steering will be referred to as EPS. The vehicle 102 is referred to as own vehicle 102 as necessary to distinguish it from another vehicle.

A microcomputer of each ECU includes a CPU, a ROM, a RAM, a readable and writable nonvolatile memory (N/M), an interface (I/F), and the like. The CPU implements various functions by executing instructions (programs, routines) stored in the ROM. Furthermore, these ECUs are connected to each other via a CAN (Controller Area Network) 104 so as to be able to exchange data (communicate). Therefore, detected values of sensors (including switches) connected to a specific ECU are transmitted to other ECUs as well.

The driving assistance ECU 10 is a central control unit that performs driving assistance control such as collision avoidance support control by automatic braking to avoid an encountered collision and lane keeping control. In the embodiment, the driving assistance ECU 10 cooperates with other ECUs to perform the collision avoidance support control by automatic braking, as will be described in detail later.

Camera sensors 12, radar sensors 14 and a switch 18 are connected to the driving assistance ECU 10. The camera sensors 12 and the radar sensors 14 include a plurality of camera devices and a plurality of radar devices, respectively. The camera sensors 12 and the radar sensors 14 function as a target information acquisition device 16 that acquires information such as targets around the vehicle 102.

Although not shown in the figure, each camera device of the camera sensors 12 includes a camera unit that captures images of the surroundings of the vehicle 102, and a recognition unit that analyzes the image data captured by the camera unit and recognizes targets such as white lines on a road and other vehicles. The recognition unit supplies information about a recognized target to the driving assistance ECU 10 every time a predetermined time elapses.

Each radar device of the radar sensors 14 has a radar transmitting/receiving unit and a signal processor (not shown). The radar transmitting/receiving unit emits radio waves in a millimeter wave band (hereinafter referred to as “millimeter waves”) around the vehicle 102, and receives millimeter waves (i.e., reflected waves) reflected by three-dimensional objects (for example, other vehicles, guardrails, etc.) existing within a radiation range. Based on a phase difference between the emitted millimeter wave and the received reflected wave, an attenuation level of the reflected wave, and a time from when the millimeter wave is emitted to when the reflected wave is received, the signal processing unit acquires every predetermined time information concerning a relative distance and a relative speed between the own vehicle and a three-dimensional object, a relative position (direction) of the three-dimensional object with respect to the own vehicle, and the like, and supplies the information to the driving assistance ECU 10. LiDAR (Light Detection And Ranging) may be used instead of or in addition to the radar sensor 14.

The switch 18 is provided at a position that can be operated by a driver, such as at a steering wheel not shown in FIG. 1, and is turned on and off by the driver. When the switch 18 is on, a signal indicating this is supplied to the driving assistance ECU 10, and the collision avoidance support control by the automatic braking is executed.

The drive ECU 20 is connected to a drive device 22 that accelerates the vehicle 102 by applying driving force to drive wheels (not shown in FIG. 1). The drive ECU 20 normally controls the drive device 22 so that the driving force generated by the drive device 22 changes according to a driving operation by the driver, and when the drive ECU 20 receives a command signal from the driving assistance ECU 10, the drive ECU 20 controls the drive device 22 based on the command signal.

The brake ECU 30 is connected to a brake device 32 that decelerates the vehicle 102 by applying braking force to wheels (not shown in FIG. 1). The brake ECU 30 normally controls the brake device 32 so that the braking force generated by the brake device 32 changes according to a braking operation by the driver, and, when the brake ECU 30 receives a command signal from the driving assistance ECU 10, the brake ECU 30 performs automatic braking by controlling the brake device 32 based on the command signal. Therefore, the brake ECU 30 and the brake device 32 function as an automatic brake device 34.

An EPS device 42 is connected to the EPS-ECU 40. The EPS-ECU 40 controls the EPS device 42 in a manner known in the art based on a steering torque Ts and a vehicle speed V detected by a driving operation sensor 60 and a vehicle state sensor 70, which will be described later to control the steering torque and reduce the driver's steering burden.

Further, the EPS-ECU 40 can steer steered wheels as necessary by controlling the EPS device 42. Therefore, the EPS-ECU 40 and the EPS device 42 function as an automatic steering device that automatically steers the steered wheels as necessary.

An alert device 52 is connected to the meter ECU 50. The alert device 52 is activated when it is determined that there is a risk that the own vehicle 102 will collide with another vehicle, and issues an alert that alerts that there is a risk that the own vehicle 102 will collide with another vehicle. The alert device 52 may be any of an alert device that issues a visual alert such as a display or an alert lamp, an alert device that issues an auditory alert such as an alert buzzer, and an alert device that issues a tactile alert such as a vibration of a seat, or any combination thereof.

The driving operation sensor 60 and the vehicle state sensor 70 are connected to the CAN 104. Information detected by the driving operation sensor 60 and the vehicle state sensor 70 (referred to as sensor information) is transmitted to the CAN 104. The sensor information transmitted to the CAN 104 can be appropriately used in each ECU. Note that the sensor information may be information of a sensor connected to a specific ECU, and may be transmitted from the specific ECU to the CAN 104.

The driving operation sensor 60 includes a driving operation amount sensor that detects an operation amount of an accelerator pedal, a braking operation amount sensor that detects a master cylinder pressure or a pressing force on a brake pedal, and a brake switch that detects whether or not the brake pedal is operated. Further, the driving operation sensor 60 includes a steering angle sensor that detects a steering angle θ, and a steering torque sensor that detects a steering torque Ts, and the like.

The vehicle state sensor 70 includes a vehicle speed sensor that detects a vehicle speed V of the vehicle 102, a longitudinal acceleration sensor that detects a longitudinal acceleration of the vehicle, a lateral acceleration sensor that detects a lateral acceleration of the vehicle, a roll angular acceleration sensor that detects a roll angular acceleration of the vehicle, and a yaw rate sensor that detects a yaw rate of the vehicle, and the like.

Furthermore, a navigation device 80 is also connected to the CAN 104. The navigation device 80 includes a GPS receiver that detects a position of the vehicle 102, a storage device that stores map information and road information, and a communication device that acquires a latest map information and road information from outside. The navigation device 80 functions as a device that acquires information on a current position of the vehicle 102, and outputs a signal indicating the current position of the vehicle on a map and map information of its surroundings to the driving assistance ECU 10.

As can be seen from the above description, in the embodiment, the target information acquisition device 16 and the navigation device 80 function as a surrounding information acquisition device that acquires information such as a road around the vehicle 102.

In the embodiment, ROM of the driving assistance ECU 10 stores a collision avoidance support control program for avoiding an encountered collision by the automatic braking. This control program corresponds to the flowchart shown in FIG. 2, and the collision avoidance support control method is executed by executing this control program.

### <Collision Avoidance Support Control Program (FIG. 2)>

Next, the collision avoidance support control according to the embodiment will be described with reference to the flowchart shown in FIG. 2. The collision avoidance support control according to the flow chart shown in FIG. 2 is repeatedly executed at predetermined intervals by the CPU of the driving assistance ECU 10 when the switch 18 is on, and is ended when the switch 18 is off. In the following description, the collision avoidance support control is referred to as “present control”.

First, in step S10, the CPU determines whether or not there is an intersection in front of the vehicle 102 based on images acquired by the front camera device of the camera sensor 12 and/or information from the navigation device 80. When a negative determination is made, the present control is once ended, and when an affirmative determination is made, the present control proceeds to step S20.

In step S20, the CPU determines, based on the information from the target information acquisition device 16, whether or not there is another vehicle traveling toward the own vehicle road on a road intersecting the own vehicle road. When a negative determination is made, the present control is once ended, and when an affirmative determination is made, the present control proceeds to step S30.

In step S30, the CPU determines whether or not the own vehicle road is a non-priority road based on the images acquired by the front camera device of the camera sensor 12 and/or the information from the navigation device 80. When an affirmative determination is made, the present control proceeds to step S50, and when a negative determination is made, the present control proceeds to step S40.

On the assumption that there is no sign of the priority road on the own vehicle road, it may be determined that the own vehicle road is a non-priority road, for example, when any of the following is confirmed.
X1: There is a center line of other vehicle road in the intersection.
X2: There is a lane boundary of the other vehicle road in the intersection.
X3: There is a center line on the own vehicle road, but the center line is not in the intersection.
X4: There is a pause or slow-going sign or road sign on the own vehicle road.
X5: There are no sign or road sign for pause or slow-going on the own vehicle road, but the width of the own vehicle road is narrower than that of the other vehicle road.

In step S40, the CPU sets a range of a mode of the collision between the other vehicle and the own vehicle to a standard collision mode range, and sets a reference value for permission determination of the automatic braking to a preset standard value.

The own vehicle and the other vehicle collide with each other at an intersection when the own vehicle and the other vehicle enter the intersection substantially at the same time, and as shown in FIG. 3, a mode of a collision depends on a timing at which the own vehicle and the other vehicle enter the intersection.

In a case (A), the other vehicle 106 enters the intersection 108 at the earliest timing compared to the own vehicle 102 in the other modes, and a front end corner of the own vehicle 102 collides with a rear end corner of the other vehicle 106. In a case (C), the own vehicle 102 and the other vehicle 106 enter the intersection 108 at the same timing, and the front end corner of the own vehicle 102 collides with a front end corner of the other vehicle 106. In a case (B), the timing at which the own vehicle 102 and the other vehicle 106 enter the intersection 108 is intermediate between the case (A) and the case (C), and the front end corner of the own vehicle 102 collides with a side portion of the other vehicle 106.

In a case (F), the other vehicle 106 enters the intersection 108 at the latest timing compared to the own vehicle 102 in the other modes, and the front end corner of the other vehicle 106 collides with the rear end corner of the own vehicle 102. In a case (E), the timing at which own vehicle 102 and the other vehicle 106 enter the intersection 108 is intermediate between the case (C) and the case (F), and the front end corner of the other vehicle 106 collides with the side portion of the own vehicle 102. In a case (D), the timing at which the other vehicle 106 enters the intersection 108 is later than in the case (C) and earlier than in the case (E), and the front end corner portion of the other vehicle 106 collides with the front end side portion of own vehicle 102.

When the own vehicle road is not a non-priority road, and in particular when the own vehicle road is a priority road, if the own vehicle is decelerated and stopped by the automatic braking in a situation where the mode of the collision is predicted to be one of the cases (D) to (F), the driver is dissatisfied thinking that the driver should have been able to pass an intersection by accelerating the own vehicle without colliding with the other vehicle. Therefore, the standard collision mode range in the embodiment is from the case (A) to the case (C), and in step S40, the collision mode range is set to the standard collision mode range from the case (A) to the case (C).

When the own vehicle road is not a non-priority road, in particular when the own vehicle road is a priority road, there is a high possibility that the other vehicle decelerates by braking and stops, thereby avoiding a collision. Therefore, the determination of whether or not the own vehicle can be automatically braked does not become affirmative as long as there is the high possibility.

As shown in FIG. 4, L is assumed to be a distance between a position P1 immediately before the other vehicle 106 collides with the own vehicle 102 and a current position P3 of the other vehicle 106. Lbmin is assumed to be a minimum value of a distance where the other vehicle 106 can be avoided from colliding with the own vehicle 102 if the other vehicle decelerates by braking, and P2 is assumed to be a position of the other vehicle 106 corresponding to the minimum value Lbmin.

When a vehicle speed of the other vehicle 106 at the position P2 is assumed to be Va and the mean deceleration by the braking of the other vehicle 106 from the position P2 to the position P1 is assumed to be Gba, a time ta required for the other vehicle 106 to move from the position P2 to the position P1 is Va/Gba. In addition, a time tb required for the other vehicle 106 to travel at the vehicle speed Va without decelerating from the current position P3 to the position P1 is L/Va. Therefore, a time during which the other vehicle 106 moves from the current position P3 to the position P2, that is, an allowance time tm in which a collision between the other vehicle 106 and the own vehicle 102 can be avoided is tb−ta=L/Va−Va/Gba.

When the collision mode is predicted to be any of the cases (A) to (E), and the other vehicle 106 is traveling at the vehicle speed Va, even if the deceleration of the own vehicle 102 is started after the allowance time tm becomes negative, the collision of the other vehicle 106 and own vehicle 102 cannot be avoided. If the deceleration of own vehicle 102 is started at the time when the allowance time tm becomes 0, the collision between the other vehicles 106 and the own vehicle 102 can be avoided. If the deceleration of the own vehicle 102 is started when the allowance time tm is a positive value, the collision between the other vehicle 106 and the own vehicle 102 can be avoided, but there is a possibility that the other vehicle 106 is stopped by the braking prior to reaching the position P1, resulting in the own vehicle 102 being wastefully stopped by the braking.

Therefore, a determination of whether or not braking of the own vehicle 102 can be started is performed by determining whether or not the allowance time tm is more than 0 and equal to or less than a reference value tc, and in step S40, the reference value tc of the permission determination for the automatic braking is set to 0, which is a preset standard value. A vehicle speed Va and a distance L of the other vehicle 106 may be determined based on the detection result of the camera sensor 12. An average deceleration Gba by the braking of the other vehicle 106 may be, for example, an average value of values experimentally obtained for various vehicles.

In step S50, the CPU expands the collision mode range so that the modes of the cases (D) to (F) in which the other vehicles collides with a side of the own vehicle are included in the collision mode range. Thus, the expanded collision mode range is from the case (A) to the case (F). In FIG. 3, the other vehicle 106 travels from the left side to the right side with respect to the own vehicle 102, but when the other vehicle 106 travels from the right side to the left side with respect to the own vehicle 102, the collision mode range is similarly expanded.

In step S60, the CPU sets the reference value tc of the permission determination for the automatic braking to be an increased value tcp (a positive constant) that is greater than 0 which is the preset standard value. In FIG. 4, the other vehicle 106 travels from left to right with respect to the own vehicle 102, but when the other vehicle 106 travels from right to left with respect to the own vehicle 102, the reference value tc is similarly set to increase to a value tcp larger than 0.

In step S70, the CPU determines whether or not there is a possibility that the own vehicle may collide with the other vehicle by determining whether or not the mode of the collision between the other vehicle and the own vehicle estimated based on the detection result of the camera sensor 12 is included in the collision mode range set in step S40 or S50. When a negative determination is made, the present control is once ended, and when an affirmative determination is made, the present control proceeds to step S80.

In step S80, the CPU determines whether or not the automatic braking is permitted by determining whether or not the allowance time tm estimated based on the detection result of the camera sensor 12 is equal to or less than the reference value tc set in step S40 or S60. When a negative determination is made, the present control is once ended, and when an affirmative determination is made, the present control proceeds to step S90.

In step S90, the CPU issues an alert to the effect that the own vehicle 102 may collide with the other vehicle by outputting a command signal to the meter ECU 50. In addition, the CPU activates the braking device 32 by outputting a command signal to the brake ECU 30, and decelerates the own vehicle 102 by the automatic braking.

In step S100, the CPU determines whether or not the own vehicle is stopped by determining whether or not the vehicle speed V of the own vehicle 102 becomes 0. When a negative determination is made, the present control returns to step S70, and when an affirmative determination is made, the present control is ended. Therefore, when affirmative determinations are made in steps S70 and S80, the issuance of the alert and the automatic braking are continued until the own vehicle is stopped.

### Operation of the Embodiment

Next, the operation of the embodiment will be described with respect to a case where there is an intersection in front of the own vehicle 102 (S10) and there is another vehicle that travels on a road intersecting an own vehicle road toward the own vehicle road (S20).

(1) When it is not Determined that the Own Vehicle Road is a Non-Priority Road (FIG. 5)

FIG. 5 shows a case where the own vehicle road 110 is a priority road and the other vehicle road 112 is a non-priority road. When it is not determined that the own vehicle road 110 is a non-priority road as in the case illustrated in FIG. 5, a negative determination is made in step S30. Therefore, in step S40, the range of the mode of the collision between the other vehicle and the own vehicle is set to the standard collision mode range from the case (A) to the case (C), and the reference value tc of the permission determination of the automatic braking is set to 0 which is the preset standard value.

Therefore, when the mode of the side collision between the other vehicle and the own vehicle estimated based on the detection result of the camera sensor 12 is the standard collision mode range from the case (A) to the case (C), it is determined that there is a possibility that the own vehicle may collide with the other vehicle in the step S70. However, when the estimated mode of side collision between the other vehicle and the own vehicle is one of the cases (D) to (F) other than the standard collision mode range, it is determined that there is no possibility that the own vehicle collides with the other vehicle in step S70. Therefore, step S90 is not performed.

Therefore, it is possible to prevent the driver from complaining that the own vehicle should have been able to pass the cross road without colliding with the other vehicle by the acceleration of the own vehicle if the own vehicle is decelerated and stopped by the automatic braking when the own vehicle road is not the non-priority road.

When the allowance time tm estimated based on the detection result of the camera sensor 12 is equal to or less than 0 which is the standard value, it is determined that the automatic braking is permitted in step S80. However, when the estimated allowance time tm is positive, it is determined in step S80 that the automatic braking is not permitted.

Therefore, it is possible to prevent the own vehicle from being automatically braked at a time point (tm>0) earlier than the time point (tm=0) at which the other vehicle cannot avoid the collision by the braking. Therefore, it is possible to prevent the own vehicle from being uselessly stopped due to the other vehicle stopping short by the braking and the own vehicle also stopping by the automatic braking.

(2) When it is Determined that the Own Vehicle Road is a Non-Priority Road (FIG. 6)

FIG. 6 shows a case where the own vehicle road 110 is a non-priority road and the other vehicle road 112 is a priority road. When it is determined that the own vehicle road 110 is a non-priority road as illustrated in FIG. 6, an affirmative determination is made in step S30. Therefore, in step S50, the range of the mode of the collision between the other vehicle and the own vehicle is set to the expanded collision mode range from the case (A) to the case (F). In addition, in step S60, the reference value tc of the permission determination for the automatic braking is set to a value tcp larger than 0.

Therefore, the determination conditions of the steps S70 and S80 are relaxed. That is, when the mode of the side collision between the other vehicle and the own vehicle estimated based on the detection result of the camera sensor 12 is not only the standard collision mode range from the case (A) to the case (C) but also the expanded collision mode range from the case (D) to the case (F), it is determined that there is a possibility that the own vehicle may collide with the other vehicle in step S70. Further, when the allowance time tm estimated based on the detection result of the camera sensor 12 becomes equal to or less than the positive value tcp, it is determined that the automatic braking is permitted in step S80. In other words, a timing at which the automatic braking is permitted is advanced.

Therefore, when it is determined that the own vehicle road is a non-priority road, the automatic braking is executed earlier than when it is determined that the own vehicle road is not a non-priority road. Therefore, it is possible to prevent the automatic braking of the own vehicle from being delayed in a situation where there is a risk of an encountered collision, and to effectively prevent the encountered collision.

Although the present disclosure has been described in detail with reference to a specific embodiment, it will be apparent to those skilled in the art that the present disclosure is not limited to the above-described embodiment, and various other embodiments are possible within the scope of the present disclosure.

For example, in the above-described embodiment, step S40 is executed when it is determined in step S30 that the own vehicle road is not a non-priority road, that is, when it is determined that the own vehicle road is a priority road, and when it is not determined whether or not the own vehicle road is a non-priority road. However, it may be determined in step S30 whether or not the own vehicle road is a priority road, step S40 may be executed when an affirmative determination is made, and steps S50 and S60 may be executed when a negative determination is made. In that case, steps S50 and S60 are executed even when it cannot be determined whether or not the own vehicle road is a priority road.

In the above-described embodiment, the collision mode range is expanded in step S50. However, regardless of the determination result in step S30, the collision mode range may be set to the standard collision mode range.

What is claimed is:

1. A collision avoidance support device comprising: a surrounding information acquisition device that acquires surrounding information around an own vehicle; and an electronic control unit configured to determine whether or not automatic braking for decelerating the own vehicle should be executed based on a predetermined determination condition in a situation where it is determined that there is a possibility of a collision between another vehicle traveling on a road intersecting an own vehicle road and the own vehicle based on the information acquired by the surrounding information acquisition device, and to decelerate the own vehicle by the automatic braking when it is determined that the automatic braking should be executed, wherein
the electronic control unit is configured to, when it is determined that the own vehicle road is a non-priority road based on the information acquired by the surrounding information acquisition device, make it easier to be determined that the automatic braking should be executed by relaxing the predetermined determination condition as compared to when it is determined that the own vehicle road is not a non-priority road.

2. The collision avoidance support device according to claim 1, wherein the determining as to whether or not the automatic braking should be executed includes determining whether or not an estimated collision mode is included in a preset collision mode range, and the electronic control unit is configured to relax the predetermined determination condition by expanding the preset collision mode range when it is determined that the own vehicle road is a non-priority road as compared to when it is determined that the own vehicle road is not a non-priority road.

3. The collision avoidance support device according to claim 1, wherein the determining as to whether or not the automatic braking should be executed includes a permission determination as to whether or not the automatic braking is permitted to be executed, and the electronic control unit is configured to relax a predetermined determination condition by changing a reference value of the determination as to whether or not the automatic braking is permitted so that the permission determination is performed earlier when it is determined that the own vehicle road is a non-priority road as compared to when it is determined that the own vehicle road is not a non-priority road.

4. A collision avoidance support method comprising: a step of determining whether or not there is a possibility that another vehicle traveling on a road intersecting an own vehicle road toward the own vehicle road may collide with an own vehicle based on surrounding information around the own vehicle acquired by a surrounding information acquisition device, a step of determining whether or not automatic braking for decelerating the own vehicle should be executed based on a predetermined determination condition, and a step of decelerating the own vehicle by the automatic braking when it is determined that the automatic braking should be executed, wherein
the collision avoidance support method further comprises a step of determining whether or not the own vehicle road is a non-priority road based on the information acquired by the surrounding information acquisition device, and a step of, when it is determined that the own vehicle road is a non-priority road, making it easier to be determined that the automatic braking should be executed by relaxing the predetermined determination condition as compared to when it is determined that the own vehicle road is not a non-priority road.

5. A non-transitory computer-readable storage medium storing a program for executing collision avoidance support control by causing an electronic control unit mounted on an own vehicle to execute a step of determining whether or not there is a possibility that another vehicle traveling on a road intersecting an own vehicle road toward the own vehicle road may collide with the own vehicle based on surrounding information around the own vehicle acquired by a surrounding information acquisition device, a step of determining whether or not automatic braking for decelerating the own vehicle should be executed based on a predetermined determination condition, and a step of decelerating the own vehicle by the automatic braking when it is determined that the automatic braking should be executed, wherein
the program further comprises a step of determining whether or not the own vehicle road is a non-priority road based on the information acquired by the surrounding information acquisition device, and a step of, when it is determined that the own vehicle road is a non-priority road, making it easier to be determined that the automatic braking should be executed by relaxing the predetermined determination condition as compared to when it is determined that the own vehicle road is not a non-priority road.
